(19) United States
(12) Patent Application Publication
(10) Pub. No.: US 2011/0070336 A1
(43) Pub. Date: Mar. 24, 2011

(54) Stabilizer System For Food And Beverage Products

(75) Inventors: William Mutilangi, Peekshill, NY (US); Ricardo Pereyra, White Plains, NY (US)

(73) Assignee: PEPSICO,INC., Purchase, NY (US)

(21) Appl. No.: 12/955,962

(22) Filed: Nov. 30, 2010

Related U.S. Application Data
(62) Division of application No. 11/738,580, filed on Apr. 23, 2007.

(51) Int. Cl. A23L 2/02; A23C 9/158; A23L 2/58; A23L 2/60; A23L 2/66; A23L 1/308; A23L 1/302; A23L 1/304

(52) U.S. Cl. 426/72; 426/590; 426/580; 426/583; 426/599

(57) ABSTRACT

A stabilizer system comprising blends of cellulose, lambda-carrageenan, and guar gum. Food products and beverages, such as energy drinks, are prepared with the stabilizer blends.

### FIELD OF THE INVENTION

This invention relates to food and beverage stabilizers and food and beverage products made therefrom.

### BACKGROUND OF THE INVENTION

It has long been known to produce foods and beverages of various formulations.

Improved and new formulations are desirable to meet changing market demands. In particular, there is perceived market demand for foods and beverages having alternative nutritional characteristics, including, for example, alternative calorie content. Also, there is perceived market demand for foods and beverages having alternative flavor profiles, including good taste, mouthfeel, body, etc.

The development of new food and beverage formulations, for example, new beverage formulations employing alternative sweeteners, flavorants, flavor enhancing agents, protein, and the like, presents challenges in addressing stability of the beverages containing such ingredients, particularly in protein and dairy applications. In addition, such challenges typically are presented in new beverage formulations developed for alternative nutritional characteristics and/or flavor profiles.

Energy drinks are an increasingly popular class of beverages that, for example, offer sustained energy by the combination of protein, complex carbohydrates, and fiber. These high protein/high fiber drinks are often unstable. It is desirable to provide a shelf-stable energy drink.

Smoothies, for example, are another popular class of beverages in the United States, typically comprising a variety of ingredients which are blended together to form a fresh, unique and healthy snack. Smoothies are known for their thick, rich mouthfeel and often employ cream, fruit, juice, dairy, soy, vegetable, vitamin and fiber components. Heretofore, such beverages were available almost exclusively at establishments such as juice bars and restaurants, which offer a multitude of custom-made smoothie beverages. In order to expand the availability of smoothies, it is, therefore, desirable to provide a shelf-stable smoothie beverage having most of the characteristics typically associated with fresh-made smoothies.

In addition, problems arising from many fresh-made beverages are thinning and phase separation with elapse of time. In other words, there is a finite, and relatively short, time in which a fresh-made beverage must be consumed before the beverage begins to thin and/or form a layer of water at the top or bottom of the beverage. It would, therefore, be desirable to have a smoothie beverage which does not suffer from this disadvantage, i.e., a shelf-stable beverage.

Stabilizing energy drinks and similar drinks and achieving a long shelf-life without product defects can be difficult. It is known to use stabilizers and stabilizer blends to avoid such product defects. Generally, stabilizer blends can contain various gums such as xanthan gum, pectin, gellan gum, cellulose gum, and guar gum. Carrageenan is a known stabilizer, typically in the form of kappa-carrageenan and iota-carrageenan. However, such carrageenans contribute to the gelling of the protein beverage over time. Such gelling makes the product unappealing to the consumer.

There is need for new stabilizer systems and beverage formulations which can satisfactorily meet the combination of objectives including nutritional, flavor, stability, shelf life, and other objectives.

Features and advantages of the invention or of certain embodiments of the invention will be apparent to those skilled in the art from the following disclosure and description of exemplary embodiments.

### BRIEF SUMMARY OF THE INVENTION

In accordance with a first aspect, a stabilizer system is provided comprising cellulose, lambda-carrageenan, and guar gum.

In accordance with another aspect, a beverage product is provided which comprises water and a stabilizer system comprising cellulose, lambda-carrageenan, and guar gum.

In accordance with another aspect, a method of preparing a beverage product is provided which comprises adding a stabilizer system comprising cellulose, lambda-carrageenan, and guar gum to water under high shear.

In accordance with another aspect, a food product is provided which comprises a stabilizer system comprising cellulose, lambda-carrageenan, and guar gum.

It will be appreciated by those skilled in the art, given the benefit of the following description of certain exemplary embodiments of the beverage and other beverage products disclosed here, that at least certain embodiments of the invention have improved or alternative formulations suitable to provide desirable taste profiles, nutritional characteristics, etc. These and other aspects, features and advantages of the invention or of certain embodiments of the invention will be further understood by those skilled in the art from the following description of exemplary embodiments.

### DETAILED DESCRIPTION OF CERTAIN EXEMPLARY EMBODIMENTS

Aspects of the invention are directed to a stabilizer system comprising blends of cellulose, lambda-carrageenan, and guar gum. The blends provide significantly less gelling capacity than stabilizer blends currently employed in the food industry. The stabilizer system provides acceptable body, mouthfeel, and shelf life stability in beverages, in particular protein-based beverages and dairy-based beverages.

Lambda-carrageenan is a non-gelling carrageenan (unlike kappa- and iota-carrageenan) and extends the shelf life of foods and beverages. Suitable non-gelling lambda-carrageenan can be purchased from FMC BioPolymer as VISCARIN GP 209F carrageenan.

The guar gum may be any suitable guar gum that exhibits good dispersibility. A suitable guar gum can be purchased from Hercules, Inc as SUPERCOL K-1 Guar Gum.

The cellulose may be any suitable cellulose gel, gum, or combination thereof. A suitable cellulose can be purchased from FMC BioPolymer as AVICEL RC 591 which is a combination of 95% cellulose gel and 5% cellulose gum.

The stabilizers provide a suitable body and mouthfeel of the beverage. For example, stabilizers may be selected to render the resulting beverage smooth and creamy, or thick and textured.

The blends are combined to provide about 80 to about 92 wt % cellulose, about 2 to about 7 wt % lambda-carrageenan, and about 8 to about 13 wt % guar gum. In one aspect the blends contain about 85 to about 88 wt % cellulose, about 2.5% to about 5 wt % lambda-carrageenan, and about 9 to about 11 wt % guar gum. The three stabilizers may be combined together or added separately to the beverage under high shear mixing. Generally, the temperature of mixing is about 125-135° F. Mixing can be done using a Silverson L4RT (England) high shear mixer, at speed 8 for 5 minutes.

In accordance with another aspect, a beverage product, such as a beverage or beverage concentrate or other product, is provided which comprises a stabilizer system comprising a blend of cellulose, lambda-carrageenan, and guar gum.

The blend is generally present in an amount of from about 0.001 to about 2% by weight based on total weight of the beverage, for example about 0.1% to about 0.8%.

The stabilizer blend is particularly useful in protein-containing products. As used herein, “protein-containing products” encompasses products containing or derived from milk from mammals, including cows and goats; plant materials, including soy beans; and mixtures thereof. Suitable proteins include, but are not limited to, milk proteins, soy proteins, fish proteins, egg proteins, microbial proteins, plant proteins, and dairy whey proteins.

The use of the stabilizer blend provides a smooth, thick texture and stability to a variety of shelf-stable beverages, including dairy based energy drinks. In addition, the blend successfully suspends solids throughout the beverage and prevents sedimentation and/or separation.

In aspects of the invention, the beverage is protein or energy drink such as a smoothie-type beverage containing protein and/or fiber and flavored with flavors such as such as vanilla or chocolate.

Additional beverage ingredients can be selected from sweeteners, vitamins, fiber, milk, milk solids, soy milk, (albumins are a whey protein fraction), coffee, coffee solids, vegetable juice, vegetable puree, tea, tea solids, preservatives, buffers, colors, flavors, and combinations thereof. Fruit juice or fruit puree may be added in small amounts such that the acidity of the fruit addition does not effect the final stable composition.

As used herein, “beverage” refers to, without limitation, smoothie beverages, protein drinks, shakes, vegetable juice drinks, dairy-based drinks, coffee and tea-based drinks and any other beverage to which a degree of thickness and/or stability is desirable; “beverage” also refers to any drink which contains suspended solids. As used herein, “smoothie” and “smoothie beverage” are used interchangeably; likewise The term “smoothie beverage” denotes a readily discernible class of beverages to one of ordinary skill in this art; in addition to encompassing any such readily discernible member of that class, as used herein, “smoothie beverage” particularly refers to a beverage with a characteristic thickness which can be attributed to the presence therein of ingredients such as sweeteners, acids, vitamins, fiber, fruit juice, fruit puree, milk, milk solids, milk proteins, soy milk, soy proteins, coffee, coffee solids, vegetable juice, vegetable puree, tea, tea solids, preservatives, buffers, colors, flavors, and combinations thereof. Smoothie beverages may be fruit-based, juice-based, dairy-based, coffee-based, soy-based, vegetable-based, tea-based or a combination thereof.

As used herein, “stable” refers to the absence of sedimentation, phase separation, striation, etc., preferably for a period of at least 6 months. As used herein, “shelf-stable” refers to an inability to support the growth of microorganisms at typical distribution temperatures over the course of shelf life, preferably over the course of at least 6 months; one of ordinary skill in this art will readily appreciate that the stable beverages of the present invention may not be shelf-stable in extreme or abusive environmental conditions.

The beverage products disclosed here optionally contain additional ingredients, including, for example, flavorings such as natural fruit flavors, botanical flavors, other flavors, and mixtures thereof. As used here, the term “fruit flavor” refers generally to those flavors derived from the edible reproductive part of a seed plant. Included are both those wherein a sweet pulp is associated with the seed, e.g., banana, tomato, cranberry and the like, and those having a small, fleshy berry. The term berry also is used here to include aggregate fruits, i.e., not “true” berries, but fruit commonly accepted as such. Examples of suitable fruit or berry sources include whole berries or portions thereof, berry juice, berry juice concentrates, berry purees and blends thereof, dried berry powders, dried berry juice powders, and the like.

Exemplary fruit flavors include the citrus flavors, e.g., orange, lemon, lime, tangerine, mandarin orange, tangelo, pomelo, and grapefruit, and such flavors as apple, grape, cherry, and pineapple flavors and the like, and mixtures thereof In certain exemplary embodiments the beverage concentrates and beverages comprise a fruit flavor component, e.g., a juice concentrate or juice. As used here, the term “botanical flavor” refers to flavors derived from parts of a plant other than the fruit. As such, botanical flavors can include those flavors derived from essential oils and extracts of nuts, bark, roots and leaves. Examples of such flavors include cola flavors, tea flavors, coffee flavors and the like, and mixtures thereof. The flavor component can further comprise a blend of various of the above-mentioned flavors. In certain exemplary embodiments of the beverage concentrates and beverages a cola flavor component is used or a tea flavor component. The particular amount of the flavor component useful for imparting flavor characteristics to the beverages of the present invention will depend upon the flavor(s) selected, the flavor impression desired, and the form of the flavor component. Those skilled in the art, given the benefit of this disclosure, will be readily able to determine the amount of any particular flavor component(s) used to achieve the desired flavor impression.

Juices suitable for use in at least certain exemplary embodiments of the beverage products disclosed here include, e.g., fruit, vegetable and berry juices. Juices can be employed in the present invention in the form of a concentrate, puree, single-strength juice, or other suitable forms. The term “juice” as used here includes single-strength fruit, berry, or vegetable juice, as well as concentrates, purees, milks, and other forms. Multiple different fruit, vegetable and/or berry juices can be combined, optionally along with other flavorings, to generate a beverage having the desired flavor. Examples of suitable juice sources include plum, prune, date, currant, fig, grape, raisin, cranberry, pineapple, peach, banana, apple, pear, guava, apricot, saskatoon berry, blueberry, plains berry, prairie berry, mulberry, elderberry, Barbados cherry (acerola cherry), choke cherry, date, coconut, olive, raspberry, strawberry, huckleberry, loganberry, currant, dewberry, boysenberry, kiwi, cherry, blackberry, quince, buckthorn, passion fruit, sloe, rowan, gooseberry, pomegranate, persimmon, mango, rhubarb, papaya, litchi, lemon, orange, lime, tangerine, mandarin orange, tangelo, pomelo, and grapefruit etc. Numerous additional and alternative juices suitable for use in at least certain exemplary embodiments will be apparent to those skilled in the art given the benefit of this disclosure. In the beverages of the present invention employing juice, juice may be used, for example, at a level of at least about 0.1% by weight of the beverage. In certain exemplary embodiments juice is employed at a level of from about 0.1% to about 3.0% by weight of the beverage. Typically, juice can be used, if at all, in an amount of from about 1% to about 2% by weight.

Certain such juices which are lighter in color can be included in the formulation of certain exemplary embodiments to adjust the flavor and/or increase the juice content of the beverage without darkening the beverage color. Examples of such juices include apple, pear, pineapple, peach, lemon, lime, orange, apricot, grapefruit, tangerine, rhubarb, cassis, quince, passion fruit, papaya, mango, guava, litchi, kiwi, mandarin, coconut, and banana. Deflavored and decolored juices can be employed if desired.

Other flavorings suitable for use in at least certain exemplary embodiments of the beverage products disclosed here include, e.g., spice flavorings, such as cassia, clove, cinnamon, pepper, ginger, vanilla spice flavorings, cardamom, coriander, root beer, sassafras, ginseng, and others. Numerous additional and alternative flavorings suitable for use in at least certain exemplary embodiments will be apparent to those skilled in the art given the benefit of this disclosure. Flavorings can be in the form of an extract, oleoresin, juice concentrate, bottler's base, or other forms known in the art. In at least certain exemplary embodiments, such spice or other flavors complement that of a juice or juice combination.

The one or more flavorings can be used in the form of an emulsion. A flavoring emulsion can be prepared by mixing some or all of the flavorings together, optionally together with other ingredients of the beverage, and an emulsifying agent. The emulsifying agent may be added with or after the flavorings mixed together. In certain exemplary embodiments the emulsifying agent is water-soluble. Exemplary suitable emulsifying agents include gum acacia, modified starch, carboxymethylcellulose, gum tragacanth, gum ghatti and other suitable gums. Additional suitable emulsifying agents will be apparent to those skilled in the art of beverage formulations, given the benefit of this disclosure. The emulsifier in exemplary embodiments comprises no greater than about 3% depending on the flavoring system of the mixture of flavorings and emulsifier. In certain exemplary embodiments the emulsifier is from about 0.05% to about 3.0% of the mixture.

The beverage concentrates and beverages disclosed here optionally may contain other additional ingredients, including, generally, any of those typically found in beverage formulations. These additional ingredients, for example, can typically be added to a stabilized beverage concentrate. Examples of such additional ingredients include, but are not limited to, caramel and other coloring agents or dyes, antifoaming agents, gums, emulsifiers, tea solids, cloud components, and mineral and non-mineral nutritional supplements. Examples of non-mineral nutritional supplement ingredients are known to those of ordinary skill in the art and include, for example, antioxidants and vitamins, including Vitamins A, D, E (tocopherol), C (sodium ascorbate), B (thiamine), B₂ (riboflavin), B₆, B₁₂, and K, niacin, folic acid, biotin, and combinations thereof. The optional non-mineral nutritional supplements are typically present in amounts generally accepted under good manufacturing practices. Exemplary amounts are between about 1% and about 100% RDV, where such RDV are established. In certain exemplary embodiments the non-mineral nutritional supplement ingredient(s) are present in an amount of from about 5% to about 20% RDV, where established.

Suitable sweeteners may be used including artificial and natural sweeteners, nutritive and non-nutritive sweeteners.

In accordance with another aspect, a method of preparing a beverage product is provided which comprises including in the beverage product a stabilizer system comprising cellulose, lambda-carrageenan, and guar gum.

For example, water is heated to about 120 F to about 140 F, for instance about 130° F. A dry blend of protein and sugar are slowly added to water while stirring. Condensed skim and cream are then added to the protein solution. The solution is then heated to about 120 F to about 140 F, for instance about 130° F. Dry ingredients are added to the dairy mixture (after reaching about 120° F.).

Avicel RC 591, carrageenan, and guar gum are dispersed in water using high shear mixer and then added to the dairy mixture. The mixture is allowed to sit for about 15 minutes to allow for complete hydration. The solids are measured and adjusted to target level by adding water. Flavors and colors are added. The stabilizer can be high sheared by adding 1 part stabilizer blend to 20 parts of water and high shearing for 5 minutes at high speed.

Generally, the finished beverage is aseptically manufactured and shelf-stable at room temperature until opened when ready for use

The stabilizer blend may also be used in food products such as cereal (snack bars) and confections such as marshmallow. The stabilizer system can also be used in dairy based desserts such as puddings, soft serve ice creams, and pie fillings such as pumpkin, coconut cream, cheese cakes, etc.

The use of the stabilizer blend provides a consistent texture and stability to a variety of shelf-stable food products. The blend useful in food products also contains about 80 to about 92 wt % cellulose, about 2 to about 7 wt % lambda-carrageenan, and about 8 to about 13 wt % guar gum.

Cereal bars typically comprise particles bound together with a mixture of sugar syrup and fat or with another binder as a matrix. The particles typically are cereals and grains, together with inclusions or additions. Inclusions and additions are selected from items such as fruit, nuts, and other bits such as chocolate bits and marshmallow bits.

The particulate dry ingredients may be selected from cereals, grains, and additions and inclusions. Cereals and grains that are part of the particulate dry ingredients are selected from those typically found in cereal bars. These cereals and grains are toasted, baked, or otherwise processed so that the cereal bar need not be baked. Cereals and grains are selected from rice, wheat, corn, barley, rye, oats, sorghum, millet, amaranth, kamut, and other cereals and grains. The identities of and relative proportions of the cereals and grains are selected to provide the desired texture and flavor. Rice can be in the form of crispy rice, also known as toasted puffed rice, or can be toasted rice extrudate. Both forms are known to skilled practitioners. Similarly, corn can be in the form of flakes, toasted puffs, or popped corn. The other cereals and grains can be processed in manners known in the art. Skilled practitioners are familiar with the various toasted, baked, and processed cereals and grains that can form part of the particulate dry ingredients of a cereal bar.

Any suitable binder may be used. The binder may contain, for example, sugar syrup, honey, and/or fat. The stabilizer system is generally added to the binder to provide a shelf-stable product. For example, the stabilizer could be dispersed in water with granulated sugar or syrup. This solution will act not only as a binder, but will retain moisture thru the stabilizer and improve “freshness” overtime. The stabilizer system may be dry blended with the protein in protein bars before baking.

### EXAMPLES

The following examples are specific embodiments of the present invention and are not intended to limit it. Unless otherwise indicated, all units are in grams.

### Example 1

A stabilizer was formulated using a non-gelling carrageenan (lambda-carrageenan).

| Ingredient | Amount |
|---|---|
| Avicel RC 591 | 86.6% |
| Lambda Carrageenan | 3.9% |
| Guar Gum | 9.5% |

All three stabilizer ingredients were dry blended at the above ratio. The resulting stabilizer blend was dispersed in water in the amount of 0.6% stabilizer blend in 400 mls water. The resulting solution was heated to 185° F., and then cooled to 40° F. and measuring the viscosity.

### Example 2

The following was combined to form a dairy beverage containing the stabilizer blend.

| INGREDIENT | % |
|---|---|
| Skim Milk | 30.0 |
| Milk protein concentrate | 3.2 |
| Sucrose | 7.0 |
| Stabilizer blend | 0.25 |
| Lycopene | 0.10 |
| Vitamin Premix | 0.015 |
| Maltodextrin | 0.50 |
| Flavors | 0.20 |
| Potassium carbonate | 0.50 |
| Water | 58.485 |
| TOTAL | 100 |

### Example 3

The following was combined to form a whey protein energy beverage containing the stabilizer blend.

| INGREDIENT | % |
|---|---|
| Whole Milk | 15.0 |
| Whey Protein concentrate | 4.2 |
| Sucrose | 7.0 |
| Stabilizer blend | 0.45 |
| Sweeteners | 0.01 |
| Vitamin Premix | 0.015 |
| Maltodextrin | 0.50 |
| Flavors | 0.12 |
| Banana puree | 0.50 |
| Water | 72.205 |
| TOTAL | 100 |

Generally, energy drinks may contain one or more of the following: Filtered water, skim milk, sugar, milk protein concentrate, sucromalt, cream, maltodextrin, natural flavor, dextrose, cellulose gel, salt, cellulose gum, guar gum, lambda-carraggenan, sodium ascorbate, D-ribose, vitamin E acetate, soy lecithin, colors such as lycopene and/or annatto, vitamin a palmitate, niacinamide, citric acid, vitamin D3, pyridoxine hydrochloride, (vitamin B6), cyanocobalamin (vitamin B 12). Fruit juices and purees may be included such as mango puree.

Given the benefit of the above disclosure and description of exemplary embodiments, it will be apparent to those skilled in the art that numerous alternative and different embodiments are possible in keeping with the general principles of the invention disclosed here. Those skilled in this art will recognize that all such various modifications and alternative embodiments are within the true scope and spirit of the invention. The appended claims are intended to cover all such modifications and alternative embodiments. It should be understood that the use of a singular indefinite or definite article (e.g., “a,” “an,” “the,” etc.) in this disclosure and in the following claims follows the traditional approach in patents of meaning “at least one” unless in a particular instance it is clear from context that the term is intended in that particular instance to mean specifically one and only one. Likewise, the term “comprising” is open ended, not excluding additional items, features, components, etc.

1. (canceled)

2. (canceled)

3. A beverage comprising water and a stabilizer system comprising a blend of about 80 to about 92 wt % cellulose, about 2 to about 7 wt % lambda-carrageenan, and about 8 to about 13 wt % guar gum wherein the stabilizer system is present in an amount ranging from about 0.001 to about 2% by total weight of the beverage, wherein the beverage is shelf stable in a closed container for at least 6 months.

4. The beverage of claim 3 comprising about 85 to about 88 wt % cellulose, about 3 to about 5 wt % lambda-carrageenan, and about 9 to about 11 wt % guar gum.

5. The beverage of claim 3 wherein the stabilizer system is present in an amount ranging from about 0.1% to about 0.8% by weight based on total weight of the beverage

6. The beverage according to claim 3 further comprising at least one ingredient selected from the group consisting of sweeteners, proteins, fiber, milk, milk solids, soy milk, albumins, vitamins, preservatives, buffers, colors, and flavors.

7. The beverage-according to claim 6 wherein the beverage comprises at least one protein selected from the group consisting of milk proteins, soy proteins, fish proteins, egg proteins, microbial proteins, plant proteins, dairy whey proteins, non-dairy whey proteins, and vegetable whey proteins.

8. The beverage according to claim 3 wherein the beverage is a dairy-based drink.

9. The beverage according to claim 3 wherein the beverage is an energy drink.

10. The beverage according to claim 9 wherein the energy drink further comprises one or more of the following: milk, cream, sweeteners, milk protein concentrate, salt, flavors, vitamins, minerals, and colors.

11. The beverage according to claim 3 wherein the energy drink comprises protein and fiber.

12-21. (canceled)

22. The beverage according to claim 3 wherein the beverage is a smoothie

23. The beverage of claim 24 wherein the smoothie is a fruit-based smoothie.

24. The beverage of claim 25 wherein the fruit-based smoothie comprises fruit juice, fruit puree, or combinations thereof.
